(19) United States
(12) Patent Application Publication
(10) Pub. No.: US 2026/0280370 A1
(43) Pub. Date: Sep. 17, 2026

(54) ROTARY SYSTEM HAVING A FLUID FLOW PATH

(71) Applicant: Schaeffler Technologies AG & Co. KG, Herzogenaurach (DE)

(72) Inventor: Zachary Gnabah, Massillon, OH (US)

(73) Assignee: Schaeffler Technologies AG & Co. KG, Herzogenaurach (DE)

(21) Appl. No.: 19/076,337

(22) Filed: Mar. 11, 2025

(51) Int. Cl. H02K 1/30; H02K 1/276; H02K 1/32

(52) U.S. Cl. CPC H02K 1/30; H02K 1/276; H02K 1/32

(57) ABSTRACT

A rotary system includes a rotor that defines a fluid flow passage. A first end cap is disposed at a first axial end of the rotor. The first end cap defines an access opening that is aligned with the fluid flow passage defined by the rotor and defines an annular channel. A rotor shaft defines an aperture that extends from an interior surface of the rotor shaft to an exterior surface of the rotor shaft. The rotor and the rotor shaft are coupled, such that the rotor and rotor shaft are operable to rotate about an axis together at a common rate of rotation. Rotation of the rotor and rotor shaft about the axis is configured to propel fluid from an interior volume of the rotor shaft, through the aperture, through the access opening, and into the fluid flow passage.

### FIELD OF THE DISCLOSURE

The present disclosure relates to a rotary system that includes a rotor that defines a portion of a fluid flow path of the rotary system. More specifically, the present disclosure relates to a rotary system that includes a rotor, a rotor shaft, a rotor flange, and an axial end cap, each of which defines a portion of a fluid flow path.

### BACKGROUND OF THE DISCLOSURE

Rotary systems often utilize fluid for lubrication and cooling.

### SUMMARY OF THE DISCLOSURE

According to a first aspect of the present disclosure, a rotary system includes a rotor that defines a fluid flow passage that extends from a first axial end of the rotor toward a second axial end of the rotor. A first end cap is disposed at the first axial end of the rotor. The first end cap defines an access opening that is aligned with the fluid flow passage defined by the rotor and defines an annular channel that faces away from the rotor for receiving a sealing element therein. A rotor shaft defines an aperture that extends from an interior surface of the rotor shaft to an exterior surface of the rotor shaft. The interior surface of the rotor shaft defines an interior volume. The rotor and the rotor shaft are coupled, such that the rotor and rotor shaft are operable to rotate about an axis together at a common rate of rotation. Rotation of the rotor and rotor shaft about the axis is configured to propel fluid from the interior volume of the rotor shaft, through the aperture defined by the rotor shaft, through the access opening defined by the first end cap, into fluid flow passage defined by the rotor, and onward therein toward the second axial end of the rotor.

Embodiments of the first aspect of the disclosure can include any one or a combination of the following features:
at least one magnet disposed within the rotor and a second end cap disposed at the second axial end of the rotor, wherein the first and second end caps are configured to retain the at least one magnet within the rotor;
the fluid flow passage defined by the rotor extends from the first axial end of the rotor to the second axial end of the rotor, and the second end cap defines an access opening that is aligned with the fluid flow passage, such that rotation of the rotor and rotor shaft about the axis is configured to propel fluid from the interior volume of the rotor shaft, through the aperture defined by the rotor shaft, through the access opening defined by the first end cap, into fluid flow passage defined by the rotor, onward therein toward the second axial end of the rotor, out of the second axial end of rotor, and through the access opening defined by the second end cap;
the first end cap includes an outboard portion and an inboard portion that is positioned radially inboard of the outboard portion, wherein a surface of the inboard portion that faces axially away from the rotor is nearer to the rotor than a surface of the outboard portion that faces axially away from the rotor, such that the inboard portion is recessed relative to the outboard portion to form a depression, and wherein the inboard portion defines the access opening, and the outboard portion defines the annular channel;
the inboard portion and the outboard portion cooperate to define a plurality of pockets that are circumferentially offset from each other, wherein at least one of the plurality of pockets includes the radially-outboard most portion of the inboard portion of the first end cap, and the access opening is defined by the first end cap proximate at least one of the plurality of pockets;
a rotor flange that is coupled with the rotor shaft and that cooperates with the first end cap to define a fluid receiving space that is disposed axially between the rotor flange and the first end cap;
the fluid receiving space and the interior volume defined by the interior surface of the rotor shaft are in fluid communication via the aperture defined by the rotor shaft;
the rotor, rotor flange, and the rotor shaft are operable to rotate about the axis together at a common rate of rotation, and the rotation about the axis is configured to propel fluid from the interior volume defined by the interior surface of the rotor shaft into the fluid receiving space via the aperture, and from the fluid receiving space into the fluid flow passage via the access opening defined by the first end cap;
the sealing element that interfaces with the first end cap and the rotor flange to seal an interface between the first end cap and the rotor flange;
the sealing element is an O-ring received within the annular channel defined by the first end cap; and
the rotor is a component of an electric motor assembly.

According to a second aspect of the present disclosure, an electric motor assembly includes a rotor that defines a fluid flow passage that extends from a first axial end of the rotor toward a second axial end of the rotor. A first end cap is disposed at the first axial end of the rotor that defines an access opening that is aligned with the fluid flow passage defined by the rotor. A rotor flange cooperates with the first end cap to define a fluid receiving space that is disposed axially between the rotor flange and the first end cap. A rotor shaft is coupled with the rotor and the rotor flange. The rotor shaft includes an interior surface that defines an interior volume and an exterior surface opposite the interior surface. The rotor shaft defines an aperture that extends from the interior surface to the exterior surface, such that the interior volume defined by the interior surface of the rotor shaft and the fluid receiving space are in fluid communication via the aperture. The rotor, the rotor flange, and the rotor shaft are operable to rotate about an axis together at a common rate of rotation. Rotation about the axis is configured to propel fluid from the interior volume defined by the interior surface of the rotor shaft into the fluid receiving space via the aperture, and from the fluid receiving space into the fluid flow passage via the access opening defined by the first end cap.

Embodiments of the second aspect of the disclosure can include any one or a combination of the following features:
the first end cap defines an annular channel within which the sealing element is received;
the sealing element is an O-ring received within the annular channel defined by the first end cap;
at least one magnet disposed within the rotor and a second end cap disposed at the second axial end of the rotor, wherein the first and second end caps are configured to retain the at least one magnet within the rotor;
the fluid flow passage defined by the rotor extends from the first axial end of the rotor to the second axial end of the rotor, and the second end cap defines an access opening that is aligned with the fluid flow passage, such that rotation of the rotor and rotor shaft about the axis is configured to propel fluid from the interior volume of the rotor shaft, through the aperture defined by the rotor shaft, through the access opening defined by the first end cap, into fluid flow passage defined by the rotor, onward therein toward the second axial end of the rotor, out of the second axial end of rotor, and through the access opening defined by the second end cap;
the first end cap includes an outboard portion and an inboard portion that is positioned radially inboard of the outboard portion, wherein a surface of the inboard portion that faces axially away from the rotor is nearer to the rotor than a surface of the outboard portion that faces axially away from the rotor, such that the inboard portion is recessed relative to the outboard portion to form a depression, and wherein the inboard portion defines the access opening, and the outboard portion defines an annular channel within which the sealing element is received; and
the inboard portion and the outboard portion cooperate to define a plurality of pockets that are circumferentially offset from each other, wherein at least one of the plurality of pockets includes the radially-outboard most portion of the inboard portion of the first end cap, and the access opening is defined by the first end cap proximate at least one of the plurality of pockets.

According to a third aspect of the present disclosure, an electric motor assembly includes a rotor that has a magnet disposed therein and that defines a fluid flow passage that extends from a first axial end of the rotor toward a second axial end of the rotor. A first end cap is disposed at the first axial end of the rotor for retaining the magnet within the rotor. The first end cap defines an annular channel and an access opening that is aligned with the fluid flow passage defined by the rotor. A rotor flange cooperates with the first end cap to define a fluid receiving space that is disposed axially between the rotor flange and the first end cap. A sealing element is received within the annular channel defined by the first end cap and extends axially between the first end cap and the rotor flange to seal an interface between the first end cap and the rotor flange. A rotor shaft is coupled with the rotor and the rotor flange. The rotor shaft includes an interior surface that defines an interior volume and an exterior surface opposite the interior surface. The rotor shaft defines an aperture that extends from the interior surface to the exterior surface such that the interior volume defined by the interior surface of the rotor shaft and the fluid receiving space are in fluid communication via the aperture. The rotor, the rotor flange, and the rotor shaft are operable to rotate about an axis together at a common rate of rotation. The rotation about the axis is configured to propel fluid from the interior volume defined by the interior surface of the rotor shaft into the fluid receiving space via the aperture, and from the fluid receiving space into the fluid flow passage via the access opening defined by the first end cap.

Embodiments of the third aspect of the disclosure can include at least the following feature:
the sealing element is an O-ring received within the annular channel.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an elevational view of a portion of a rotary system that includes a rotor, first and second end caps, a rotor shaft, and a rotor flange, according to one embodiment;

FIG. 2 is a cross-sectional view of the rotary system of FIG. 1 taken at line II-II according to one embodiment;

FIG. 3 is a cross-sectional view of a portion of a rotary system, illustrating a rotor that defines a plurality of fluid flow passages, a rotor shaft that defines a plurality of apertures, and first and second end caps, wherein the first end cap defines a plurality of access openings that are respectively aligned with the plurality of fluid flow passages, and an annular channel within which a sealing element is received, according to one embodiment;

FIG. 4 is a perspective view of a rotor, a rotor shaft, and a first end cap that is disposed on an axial end of the rotor, according to one embodiment;

FIG. 5 is a cutaway view of the rotary system of FIG. 4, illustrating the fluid flow passage defined by the rotor and aligned with the access opening defined by the first end cap, according to one embodiment; and

FIG. 6 is a cross-sectional view of the rotary system of FIG. 1 taken at line VI-VI, illustrating a plurality of magnets received within a rotor, and a plurality of fluid flow passages defined by the rotor, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along an axis of rotation about which one or more components are configured to rotate in operation of the apparatus described herein. Further, the term “radial” and derivatives thereof, such as “radially,” shall be understood in relation to the axis. For example, “radially outboard” refers to further away from the axis, while “radially inboard” refers to nearer to the axis. The term “circumferential” and derivatives thereof, such as “circumferentially,” shall be understood in relation to the axis. These terms shall be understood in relation to the axis about which one or more components are configured to rotate in operation of the apparatus even as the terms are applied to components of the apparatus that are not configured to rotate about the axis in operation of the apparatus. For example, the terms, “axial,” “radial,” “circumferential,” and derivates thereof shall be understood in relation to an axis about which a rotor shaft 26 of an electric drive unit is configured rotate, but can be used herein in relation to, for example, a stator of the electric drive unit that is not configured to rotate about the axis.

As used herein, “non-rotatably connected” elements shall be understood to refer to elements that are connected such that whenever one of the elements rotates about the axis, all of the elements rotate about the axis at a common rate of rotation, and relative rotation between the elements is restricted.

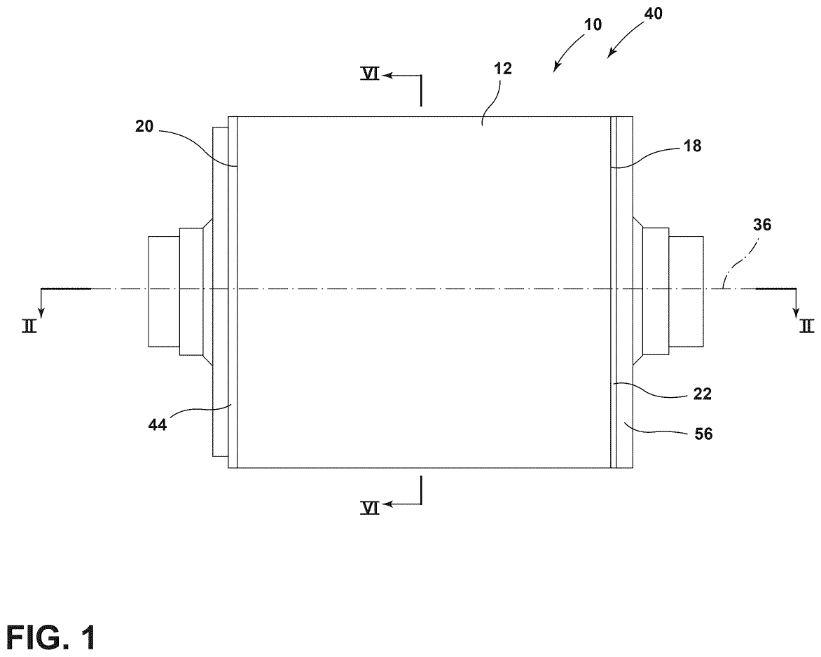

Referring now to FIGS. 1-6, a rotary system 10 includes a rotor 12. The rotor 12 can include a magnet 14 that is disposed within the rotor 12, and the rotor 12 defines a fluid flow passage 16 that extends from a first axial end 18 of the rotor 12 toward a second axial end 20 of the rotor 12. A first end cap 22 is disposed at the first axial end 18 of the rotor 12. The first end cap 22 is configured to retain the magnet 14 within the rotor 12. The first end cap 22 defines an access opening 24 that is aligned with the fluid flow passage 16 defined by the rotor 12. A rotor shaft 26 defines an aperture 28 that extends from an interior surface 30 of the rotor shaft 26 to an exterior surface 32 of the rotor shaft 26. The interior surface 30 of the rotor shaft 26 defines an interior volume 34. The rotor 12 and the rotor shaft 26 are coupled such that the rotor 12 and the rotor shaft 26 are operable to rotate about an axis 36 together at a common rate of rotation. Rotation of the rotor 12 and the rotor shaft 26 about the axis 36 is configured to propel fluid 38 from the interior volume 34 of the rotor shaft 26, through the aperture 28 defined by the rotor shaft 26, through the access opening 24 defined by the first end cap 22, into the fluid flow passage 16 defined by the rotor 12, and onward therein toward the second axial end 20 of the rotor 12.

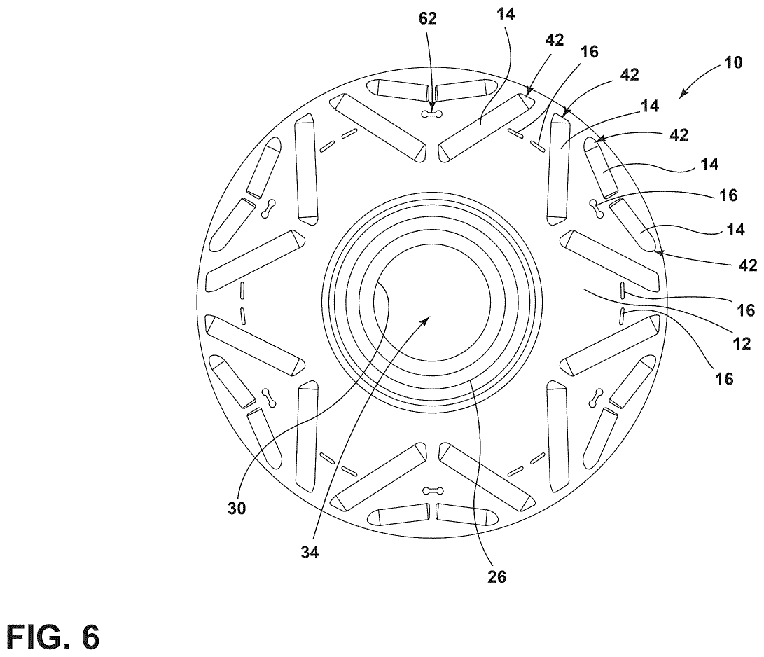

Referring still to FIGS. 1-6, the rotary system 10 includes the rotor 12. The rotor 12 is configured to rotate about the axis 36 in operation of the rotary system 10. In some embodiments, the rotor 12 of the rotary system 10 may be a component of an electric motor assembly 40 that, for example, may include a stator (not shown) configured to interact with the rotor 12 to drive rotation of the rotor 12 about the axis 36. It is contemplated that the rotor 12 may be portion of a variety of types of rotary systems 10 (e.g., alternator of a generator, etc.), in various embodiments. The rotor 12 can have the magnet 14 disposed therein. For example, in the embodiment illustrated in FIG. 6, the rotor 12 includes a plurality of magnet pockets 42 within which a plurality of magnets 14 are received. In the illustrated embodiment, the rotor 12 is a portion of a permanent magnet electric motor that utilizes interaction between a stator (not shown) and the plurality of magnets 14 received within the rotor 12 to drive rotation of the rotor 12 about the axis 36. It is contemplated that, in various embodiments, the rotor may not include magnets. For example, the electric motor assembly may be a reluctance motor having a rotor that does not utilize magnets, in some embodiments.

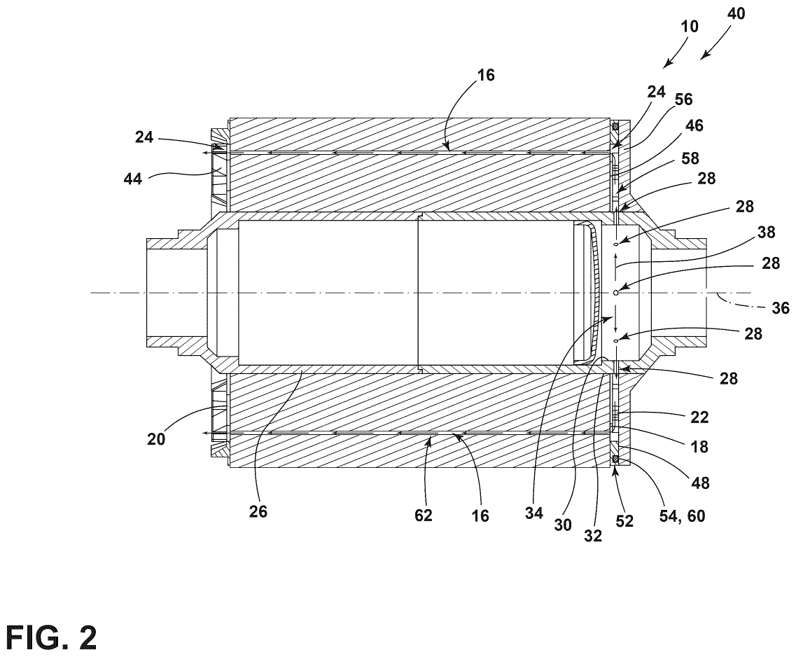

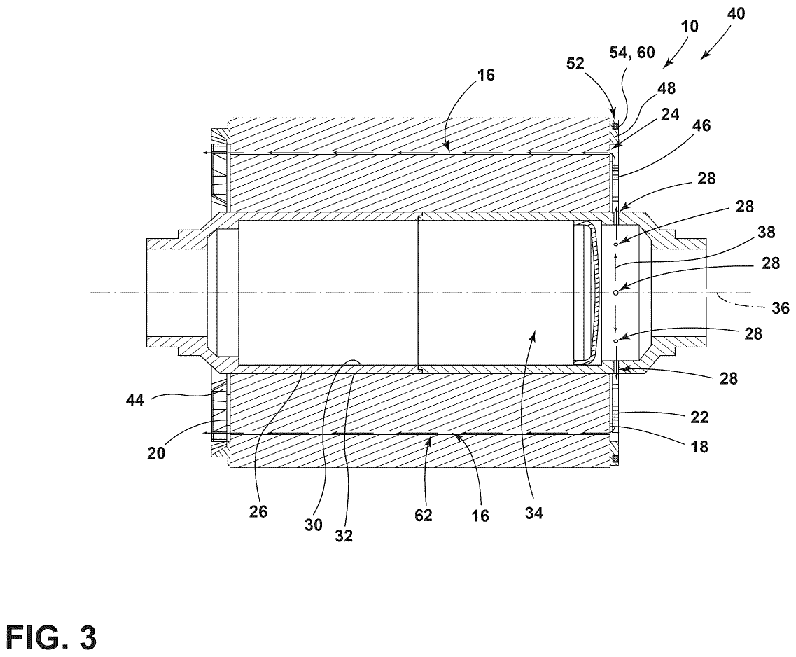

Referring now to FIGS. 2, 3, 5, and 6, the rotor 12 defines the fluid flow passage 16. In various implementations, the rotor 12 includes a plurality of fluid flow passages 16, as illustrated in FIGS. 2, 3, 5, and 6. The fluid flow passage 16 extends from the first axial end 18 of the rotor 12 toward the second axial end 20 of the rotor 12. As illustrated in FIGS. 2 and 3, in some embodiments, the fluid flow passage 16 extends from the first axial end 18 of the rotor 12 to the second axial end 20 of the rotor 12. It is understood that, in some embodiments, the fluid flow passage 16 extends toward the second axial end 20 of the rotor 12 and does not extend to the second axial end 20 of the rotor 12, and that, in some embodiments, the fluid flow passage 16 may extend toward the second axial end 20 of the rotor 12 and to the second axial end 20, as illustrated in FIGS. 2 and 3. The fluid flow passage 16 is configured to convey fluid 38 within the rotor 12 for the purpose of cooling the rotor 12 via heat transfer from the rotor 12 to the fluid 38 flowing within the fluid flow passage 16. In various embodiments, the fluid flow passage 16 is positioned proximate to the magnets 14 received within the rotor 12. For example, as illustrated in FIG. 6, the plurality of fluid flow passages 16 are radially, axially, and/or circumferentially aligned with the plurality of magnets 14 received within the rotor 12. This alignment and general proximity of the fluid flow passages 16 with the magnets 14 can advantageously aid in cooling the rotor 12 and/or the magnets 14 received within the rotor 12 efficiently.

Referring now to FIGS. 2-6, the rotary system 10 includes the first end cap 22. As illustrated in FIGS. 2 and 3, the rotary system 10 includes the first end cap 22 and a second end cap 44. The first end cap 22 is disposed at the first axial end 18 of the rotor 12 and can be configured to retain the magnet 14 within the rotor 12. The second end cap 44 is disposed at the second axial end 20 of the rotor 12, such that the rotor 12 is disposed axially between the first and second end caps 22, 44. The second end cap 44 can be configured to retain the magnet 14 within the rotor 12. In various embodiments, the first and second end caps 22, 44 cooperate to retain a plurality of magnets 14 within the rotor 12, the first end cap 22 preventing removal of the magnets 14 from the first axial end 18 of the rotor 12, and the second end cap 44 preventing removal of the magnets 14 from the second axial end 20 of the rotor 12. In some embodiments, the first and/or second end caps 22, 44 are molded. For example, the first and/or second end caps 22, 44 may be the product of transfer molding, wherein the rotor 12 and the plurality of magnets 14 received within the corresponding magnet pockets 42 of the rotor cooperate with one or more forms to defines one or more molds within which material is disposed to create the first and/or second end caps 22, 44. In such embodiments, the first and/or second end caps 22, 44 may extend into the magnet pockets 42. In various implementations, the one or more forms utilized in the mold may include features that result in the first and/or second end caps 22 forming and/or defining various corresponding features (e.g., access opening 24, annular channel 52, inboard portion 46, outboard portion 48, pockets 50, etc.).

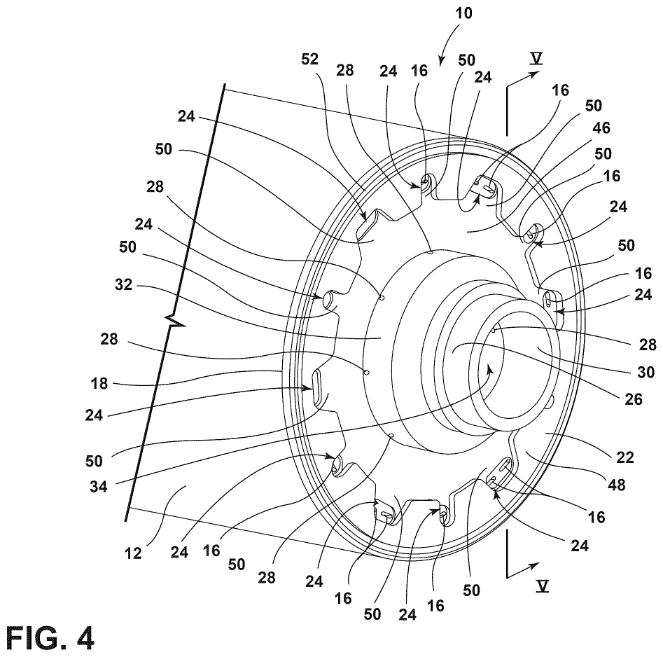

Referring now to FIGS. 2-5, the first end cap 22 defines the access opening 24. The access opening 24 is aligned with the fluid flow passage 16 defined by the rotor 12. In various implementations, the first end cap 22 defines a plurality of access openings 24. For example, as illustrated in FIG. 4, the first end cap 22 defines the plurality of access openings 24, and each of the plurality of fluid flow passages 16 defined by the rotor 12 are aligned with at least one of the plurality of access openings 24 defined by the first end cap 22. In various embodiments, the second end cap 44 can include an access opening 24. As illustrated in FIGS. 2 and 3, the second end cap 44 includes a plurality of access openings 24 that are aligned with corresponding fluid flow passages 16 at the second axial end 20 of the rotor 12.

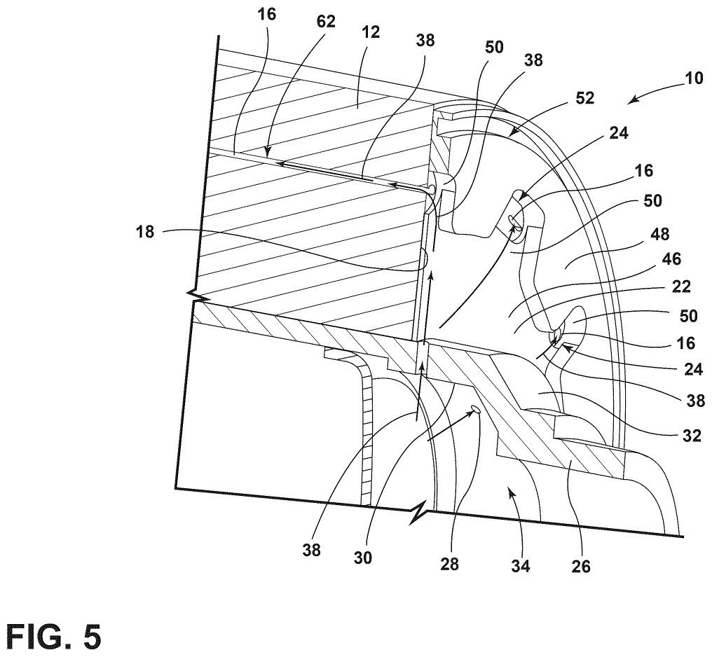

In the exemplary embodiment illustrated in FIGS. 4 and 5, the first end cap 22 includes an inboard portion 46 and an outboard portion 48. The inboard portion 46 is positioned generally radially inboard of the outboard portion 48, and a surface of the inboard portion 46 that faces axially away from the rotor 12 is nearer to the rotor 12 than a surface of the outboard portion 48 that faces axially away from the rotor 12. As such, the inboard portion 46 is recessed relative outboard portion 48 of the first end cap 22 to form a depression, as illustrated in FIGS. 4 and 5. In the illustrated embodiment, the inboard portion 46 extends radially-outboard to varying degrees at various circumferential positions, such that the inboard portion 46 and outboard portion 48 cooperate to define a plurality of pockets 50 that are circumferentially offset from each other. At least one of the pockets 50 includes the radially-outboard most portion of the inboard portion 46 of the first end cap 22, in various embodiments. The access opening 24 can be defined by the first end cap 22 at a pocket 50. As illustrated in FIGS. 4 and 5, the plurality of access openings 24 are defined by the first end cap 22 at the corresponding plurality of pockets 50. In the illustrated embodiment, the access openings 24 are apertures 28 that extend axially through the first end cap 22 at the pockets 50.

Referring now to FIGS. 2-5, in various implementations, the first end cap 22 defines an annular channel 52. The annular channel 52 may be defined by a surface of the first end cap 22 that faces away from the rotor 12. The annular channel 52 can be disposed radially outboard of the access openings 24, in various embodiments. As illustrated exemplarily in FIG. 4, the annular channel 52 is defined by the outboard portion 48 of the first end cap 22 on a surface of the outboard portion 48 that faces away from the rotor 12. The annular channel 52 extends circumferentially along the first end cap 22 at a radial position, such that the pockets 50, access openings 24, and fluid flow passages 16 aligned with the access openings 24 are disposed radially inboard of the annular channel 52. In various implementations, the annular channel 52 is configured to receive a sealing element 54 therein for sealing an interface between the first end cap 22 and a rotor flange 56, as illustrated in FIG. 2 and described further herein.

Referring now to FIGS. 3-5, the rotary system 10 includes the rotor shaft 26. The rotor shaft 26 is coupled with the rotor 12, such that the rotor 12 and the rotor shaft 26 are operable to rotate about the axis 36 together at a common rate of rotation. As illustrated in FIG. 3, the rotor shaft 26 includes the interior surface 30 and the exterior surface 32 opposite the interior surface 30. The interior surface 30 of the rotor shaft 26 defines the interior volume 34 of the rotor shaft 26. The rotor shaft 26 defines the aperture 28. As illustrate in FIGS. 3-5, in various implementations, the rotor shaft 26 defines a plurality of apertures 28. The aperture 28 extends from the interior surface 30 of the rotor shaft 26 to the exterior surface 32 of the rotor shaft 26. In an exemplary embodiment, the aperture 28 is a cross-drilled hole that extends radially through the rotor shaft 26 from the interior surface 30 to the exterior surface 32.

Referring now to FIG. 2, in various implementations, the rotary system 10 includes the rotor flange 56. The rotor flange 56 can be coupled to the rotor shaft 26 and extends radially outboard therefrom. In various embodiments, the rotor 12, the rotor shaft 26, and the rotor flange 56 are operable to rotate about the axis 36 together at a common rate of rotation. It is contemplated that the rotor flange 56 and the shaft can be integrally coupled with each other in some implementations. As illustrated in FIG. 2, the rotor flange 56 can cooperate with the first end cap 22 to define a fluid receiving space 58 that is disposed axially between the rotor flange 56 and the first end cap 22. In various embodiments, the rotary system 10 includes the sealing element 54 that interfaces with the first end cap 22 and the rotor flange 56 to seal an interface between the first end cap 22 and the rotor flange 56. As illustrated in FIG. 2, the sealing element 54 is an O-ring 60 that is received within the annular channel 52 defined by the first end cap 22. The sealing element 54 extends axially between the first end cap 22 and the rotor flange 56 to seal the interface between the first end cap 22 and the rotor flange 56. As illustrated in FIG. 2, the fluid receiving space 58 defined by the rotor flange 56 and the first end cap 22 and the interior volume 34 defined by the interior surface 30 of the rotor shaft 26 are in fluid communication with each other via the aperture 28 defined by the rotor shaft 26.

Referring now to FIGS. 2 and 5, fluid 38 may flow within various components of the rotary system 10. For example, the rotary system 10 can include a fluid path 62 along which fluid 38 flows for the purpose of lubrication and/or cooling of the rotary system 10. In various embodiments, fluid 38 is configured to flow within the interior volume 34 of the rotor shaft 26. Rotation of the rotor shaft 26 is configured to propel fluid 38 from the interior volume 34 of the rotor shaft 26 along a portion of the fluid path 62. In an exemplary implementation, rotation of the rotor 12, rotor shaft 26, and rotor flange 56 about the axis 36 is configured to propel fluid 38 from the interior volume 34 of the rotor shaft 26, through the aperture 28 defined by the rotor shaft 26, through the access opening 24 defined by the first end cap 22, into the fluid flow passage 16 defined by the rotor 12, and onward therein toward the second axial end 20 of the rotor 12, as illustrated in FIG. 5. As shown in FIG. 2, in some implementations, the fluid 38 flowing toward the second axial end 20 of the rotor 12 subsequently flows out of the second axial end 20 of the rotor 12 and through the access opening 24 defined by the second end cap 44. In the embodiment illustrated in FIG. 2, rotation of the rotor 12, rotor shaft 26, and rotor flange 56 about the axis 36 is configured to propel the fluid 38 from the interior volume 34 defined by the interior surface 30 of the rotor shaft 26 into the fluid receiving space 58 defined cooperatively by the first end cap 22 and the rotor flange 56 via the aperture 28 defined by the rotor shaft 26, and from the fluid receiving space 58 into the fluid flow passage 16 via the access opening 24 defined by the first end cap 22.

Referring now still to FIGS. 2 and 5, in operation of an exemplary embodiment of the rotary system 10, fluid 38 is disposed within the interior volume 34 of the rotor shaft 26. Rotation of the rotor shaft 26 causes the fluid 38 to flow radially outboard where the fluid 38 exits the interior volume 34 via the plurality of apertures 28 defined by the rotor shaft 26. The fluid 38 flows out of the apertures 28 and into the fluid receiving space 58 defined axially between the rotor flange 56 and the first end cap 22. Because the rotor flange 56 and the first end cap 22 are rotating about the axis 36, the fluid 38, again flows radially outboard within the fluid receiving space 58 to the pockets 50 defined by the inboard portion 46 of the first end cap 22. The fluid 38 then flows through the access openings 24 defined by the first end cap 22 at the pockets 50 and into the plurality of fluid flow passages 16 that are defined by the rotor 12 and aligned with the access openings 24. The fluid 38 flows axially along the fluid flow passages 16 toward the second axial end 20 of the rotor 12 and absorbs heat to cool the rotor 12 and/or the magnets 14 dispose therein.

The rotary system 10 of the present disclosure provides a variety of advantages. First, the first end cap 22 serving as a magnet 14 retaining feature and providing an annular channel 52 for receiving a sealing element 54 therein provides an efficient means of retaining magnets 14 within the rotor 12 and ensuring that sealed, fluid-based cooling of the rotor 12 is feasible. Second, the first end cap 22 having the access openings 24 defined at the pockets 50 ensures that rotation of the first end cap 22 about the axis 36 in operation of the rotary system 10 results in fluid 38 reliably flowing into the access openings 24 and the aligned fluid flow passages 16 thereafter.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 rotary system
12 rotor
14 magnet
16 fluid flow passage
18 first axial end
20 second axial end
22 first end cap
24 access opening
26 rotor shaft
28 aperture
30 interior surface
32 exterior surface
34 interior volume
36 axis
38 fluid
40 electric motor assembly
42 magnet pocket
44 second end cap
46 inboard portion
48 outboard portion
50 pockets
52 annular channel
54 sealing element
56 rotor flange
58 fluid receiving space
60 O-ring
62 fluid path

What is claimed is:

1. A rotary system, comprising:
a rotor that that defines a fluid flow passage that extends from a first axial end of the rotor toward a second axial end of the rotor;
a first end cap disposed at the first axial end of the rotor that defines an access opening that is aligned with the fluid flow passage defined by the rotor and that defines an annular channel that faces away from the rotor for receiving a sealing element therein; and
a rotor shaft defining an aperture that extends from an interior surface of the rotor shaft that defines an interior volume to an exterior surface of the rotor shaft, wherein the rotor and the rotor shaft are coupled, such that the rotor and rotor shaft are operable to rotate about an axis together at a common rate of rotation, and rotation of the rotor and rotor shaft about the axis is configured to propel fluid from the interior volume of the rotor shaft, through the aperture defined by the rotor shaft, through the access opening defined by the first end cap, into fluid flow passage defined by the rotor, and onward therein toward the second axial end of the rotor.

2. The rotary system of claim 1, further comprising:
at least one magnet disposed within the rotor; and
a second end cap disposed at the second axial end of the rotor, wherein the first and second end caps are configured to retain the at least one magnet within the rotor.

3. The rotary system of claim 2, wherein the fluid flow passage defined by the rotor extends from the first axial end of the rotor to the second axial end of the rotor, and the second end cap defines an access opening that is aligned with the fluid flow passage, such that rotation of the rotor and rotor shaft about the axis is configured to propel fluid from the interior volume of the rotor shaft, through the aperture defined by the rotor shaft, through the access opening defined by the first end cap, into fluid flow passage defined by the rotor, onward therein toward the second axial end of the rotor, out of the second axial end of rotor, and through the access opening defined by the second end cap.

4. The rotary system of claim 1, wherein the first end cap includes an outboard portion and an inboard portion that is positioned radially inboard of the outboard portion, wherein a surface of the inboard portion that faces axially away from the rotor is nearer to the rotor than a surface of the outboard portion that faces axially away from the rotor, such that the inboard portion is recessed relative to the outboard portion to form a depression, and wherein the inboard portion defines the access opening, and the outboard portion defines the annular channel.

5. The rotary system of claim 4, wherein the inboard portion and the outboard portion cooperate to define a plurality of pockets that are circumferentially offset from each other, wherein at least one of the plurality of pockets includes the radially-outboard most portion of the inboard portion of the first end cap, and the access opening is defined by the first end cap proximate at least one of the plurality of pockets.

6. The rotary system of claim 1, further comprising:
a rotor flange that is coupled with the rotor shaft and that cooperates with the first end cap to define a fluid receiving space that is disposed axially between the rotor flange and the first end cap.

7. The rotary system of claim 6, wherein the fluid receiving space and the interior volume defined by the interior surface of the rotor shaft are in fluid communication via the aperture defined by the rotor shaft.

8. The rotary system of claim 7, wherein the rotor, rotor flange, and the rotor shaft are operable to rotate about the axis together at a common rate of rotation, and the rotation about the axis is configured to propel fluid from the interior volume defined by the interior surface of the rotor shaft into the fluid receiving space via the aperture, and from the fluid receiving space into the fluid flow passage via the access opening defined by the first end cap.

9. The rotary system of claim 7, further comprising:
the sealing element that interfaces with the first end cap and the rotor flange to seal an interface between the first end cap and the rotor flange.

10. The rotary system of claim 9, wherein the sealing element is an O-ring received within the annular channel defined by the first end cap.

11. The rotary system of claim 1, wherein the rotor is a component of an electric motor assembly.

12. An electric motor assembly, comprising:
a rotor that defines a fluid flow passage that extends from a first axial end of the rotor toward a second axial end of the rotor;
a first end cap disposed at the first axial end of the rotor that defines an access opening that is aligned with the fluid flow passage defined by the rotor;
a rotor flange that cooperates with the first end cap to define a fluid receiving space that is disposed axially between the rotor flange and the first end cap;
a sealing element that interfaces with the first end cap and the rotor flange to seal an interface between the first end cap and the rotor flange; and
a rotor shaft that is coupled with the rotor and the rotor flange and that includes an interior surface that defines an interior volume and an exterior surface opposite the interior surface, the rotor shaft defining an aperture that extends from the interior surface to the exterior surface such that the interior volume defined by the interior surface of the rotor shaft and the fluid receiving space are in fluid communication via the aperture, wherein the rotor, rotor flange, and the rotor shaft are operable to rotate about an axis together at a common rate of rotation, and the rotation about the axis is configured to propel fluid from the interior volume defined by the interior surface of the rotor shaft into the fluid receiving space via the aperture, and from the fluid receiving space into the fluid flow passage via the access opening defined by the first end cap.

13. The electric motor assembly of claim 12, wherein the first end cap defines an annular channel within which the sealing element is received.

14. The electric motor assembly of claim 13, wherein the sealing element is an O-ring received within the annular channel defined by the first end cap.

15. The electric motor assembly of claim 12, further comprising:
at least one magnet disposed within the rotor; and
a second end cap disposed at the second axial end of the rotor, wherein the first and second end caps are configured to retain the at least one magnet within the rotor.

16. The electric motor assembly of claim 15, wherein the fluid flow passage defined by the rotor extends from the first axial end of the rotor to the second axial end of the rotor, and the second end cap defines an access opening that is aligned with the fluid flow passage, such that rotation of the rotor and rotor shaft about the axis is configured to propel fluid from the interior volume of the rotor shaft, through the aperture defined by the rotor shaft, through the access opening defined by the first end cap, into fluid flow passage defined by the rotor, onward therein toward the second axial end of the rotor, out of the second axial end of rotor, and through the access opening defined by the second end cap.

17. The electric motor assembly of claim 12, wherein the first end cap includes an outboard portion and an inboard portion that is positioned radially inboard of the outboard portion, wherein a surface of the inboard portion that faces axially away from the rotor is nearer to the rotor than a surface of the outboard portion that faces axially away from the rotor, such that the inboard portion is recessed relative to the outboard portion to form a depression, and wherein the inboard portion defines the access opening, and the outboard portion defines an annular channel within which the sealing element is received.

18. The electric motor assembly of claim 17, wherein the inboard portion and the outboard portion cooperate to define a plurality of pockets that are circumferentially offset from each other, wherein at least one of the plurality of pockets includes the radially-outboard most portion of the inboard portion of the first end cap, and the access opening is defined by the first end cap proximate at least one of the plurality of pockets.

19. An electric motor assembly, comprising:
a rotor that has a magnet disposed therein and that defines a fluid flow passage that extends from a first axial end of the rotor toward a second axial end of the rotor;
a first end cap disposed at the first axial end of the rotor for retaining the magnet within the rotor, wherein the first end cap defines an annular channel and an access opening that is aligned with the fluid flow passage defined by the rotor;
a rotor flange that cooperates with the first end cap to define a fluid receiving space that is disposed axially between the rotor flange and the first end cap;
a sealing element that is received within the annular channel defined by the first end cap and extends axially between the first end cap and the rotor flange to seal an interface between the first end cap and the rotor flange; and
a rotor shaft that is coupled with the rotor and the rotor flange and that includes an interior surface that defines an interior volume and an exterior surface opposite the interior surface, the rotor shaft defining an aperture that extends from the interior surface to the exterior surface such that the interior volume defined by the interior surface of the rotor shaft and the fluid receiving space are in fluid communication via the aperture, wherein the rotor, rotor flange, and the rotor shaft are operable to rotate about an axis together at a common rate of rotation, and the rotation about the axis is configured to propel fluid from the interior volume defined by the interior surface of the rotor shaft into the fluid receiving space via the aperture, and from the fluid receiving space into the fluid flow passage via the access opening defined by the first end cap.

20. The electric motor assembly of claim 19, wherein the sealing element is an O-ring received within the annular channel.
